(19) United States
(12) Patent Application Publication
(10) Pub. No.: US 2002/0174434 A1
(43) Pub. Date: Nov. 21, 2002

(54) Virtual broadband communication through bundling of a group of circuit switching and packet switching channels

(76) Inventors: Tsu-Chang Lee, Los Altos, CA (US); Hsi-Sheng Chen, Fremont, CA (US); Song H. An, San Diego, CA (US)

Correspondence Address: Arnold M. de Guzman, de Guzman, Okamoto & Benedicto LLP, P. O. Box 51900, Palo Alto, CA, 94303, US

(21) Appl. No.: 09/942,524

(22) Filed: Aug. 29, 2001

Related U.S. Application Data
(60) Provisional application No. 60/291,910, filed on May 18, 2001.

(51) Int. Cl. H04N 7/18; H04N 7/173

(52) U.S. Cl. 725/74; 725/81; 725/95

(57) ABSTRACT

A method of transmitting data across a telecommunication network, includes: partitioning a data stream into a plurality sub-streams; transmitting each sub-stream across an associated circuit switching channel in one communication session; and reconstructing the plurality of sub-streams into a single data stream. An apparatus for transmitting data from a source to a destination, includes: a channel bundler and de-bundler capable to partition a data stream into a plurality of sub-streams, the data stream transmitted from the source, the channel bundler and de-bundler capable to reconstruct the sub-streams into a single data stream for transmission to the destination; and a plurality of circuit switching channels communicatively coupled to the channel bundler and de-bundler and capable to transmit an assigned sub-stream.

### CROSS-REFERENCE TO RELATED APPLICATION

The present application claims priority to U.S. Provisional Application No. 60/291,910, by common inventors, Tsu-Chang Lee, Hsi-Sheng Chen, and Song Howard An, filed May 18, 2001, and entitled “SCALABLE VIDEO ENCODING/STORAGE/DISTRIBUTION/DECODING FOR SYMMETRICAL MULTIPLE VIDEO PROCESSORS”. Application No. 60/291,910 is fully incorporated herein by reference.

### TECHNICAL FIELD

This disclosure relates generally to telecommunications networks, and more particularly but not exclusively, to systems, devices, and methods for providing a virtual broadband network including virtual broadband channels.

### BACKGROUND

In the telecommunication field, two types of networks are currently known: (1) networks with circuit switching channels, and (2) networks with packet switching channels. A commonly known network with the circuit switching channels is the telephone system. Different types of telephone systems exist such as the plain old telephone system (POTS), Integrated Service Digital Network (ISDN), and the wireless mobile phone systems (e.g., 2G and 3G). Currently, there are worldwide more than five-hundred (500) million lines of POTS (wired channels) and 2G mobile (wireless channels).

Although networks with circuit switching channels can guarantee the transmission delay across the links (and hence guarantee the quality of service (QoS) of the links), this type of network is limited in bandwidth. For example, there is only 33.6 Kbps of bandwidth available for POTS and only 14.4 Kbps of bandwidth available for 2G mobile. In contrast, a high quality (CD-like) video stream or clip requires a data rate of 384 Kbps to achieve real time video distribution.

On the other hand, networks with packet switching channels (such as the Internet) have proven to be more efficient in terms of bandwidth utilization and this type of network is the new telecommunication infrastructure that is being rolled out phase-by-phase. However, packet switching channels can not guarantee the transmission delay across the links (and hence can not guarantee the quality of service (QoS) of the links). For example, an electronic mail (e-mail) message that is sent via the packet switching channels will not have a predictable arrival time at the e-mail destination, since the transmission delay will depend, in part, on the independent routing decision at each node in the packet switching channels. Therefore, it is undesirable to use networks with packet switching channels for time-sensitive or critical applications. For example, for telephone conferences, video conferences, or security or monitoring applications, the unpredictable delay of packet switching channels is not desirable.

Accordingly, there is a business and/or commercial need for a new system, device, and/or method to permit the transmission of high bit rate content while providing a guarantee to the quality of service. There is also a need for a new system, device and/or method that will be compatible with existing networks as the telecommunication network infrastructure transitions from circuit switching channels technology to packet switching channels technology.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of a telecommunications system that can implement a virtual broadband communication channel in accordance with an embodiment of the invention.

FIG. 2 is a block diagram illustrating a system for assigning priority or importance in a group obtained from a data sub-stream.

FIG. 3 is a block diagram illustrating a system for performing dynamic allocation and bit stream distribution.

FIG. 4 is a block diagram illustrating another embodiment of the invention.

FIG. 5 is a block diagram illustrating another embodiment of the invention.

FIG. 6 is a block diagram illustrating another embodiment of the invention.

FIG. 7 is a block diagram illustrating a secured data transmission feature according to an embodiment of the invention.

FIG. 8 is a block diagram of a high-end security monitoring system in accordance with an embodiment of the invention.

### DETAILED DESCRIPTION OF THE ILLUSTRATED EMBODIMENTS

In an embodiment, the invention advantageously permits the distribution of high quality real time video (e.g., compressed and/or interactive video) by use of the existing telecommunication infrastructure. A major benefit of this embodiment is a fast time-to-market without the need to wait for the prolonged broadband infrastructure deployment. Another major benefit of an embodiment of the invention is the ability to integrate the various features for packet-centric transmission.

In the description herein, numerous specific details are provided, such as examples of system components and/or methods, to provide a thorough understanding of embodiments of the invention. One skilled in the relevant art will recognize, however, that the invention can be practiced without one or more of the specific details, or with other systems, methods, components, materials, parts, and/or the like. In other instances, well-known structures, materials, or operations are not shown or described in detail to avoid obscuring aspects of the invention.

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Additionally, the signal arrows in the drawings/figures are considered as exemplary and are not limiting, unless otherwise specifically noted. Furthermore, the term “or” as used in this disclosure is generally intended to mean “and/or” unless otherwise indicated. Combinations of components or steps will also be considered as being noted, where terminology is foreseen as rendering the ability to separate or combine is unclear.

It will also be appreciated that one or more of the elements depicted in the drawings/figures can also be implemented in a more separated or integrated manner, or even removed or rendered as inoperable in certain cases, as is useful in accordance with a particular application.

Headings or sub-heading have been added below for purposes of explaining at least one of the functionality of the invention in additional details, and these headings or sub-headings should not be construed as limitations of the invention.

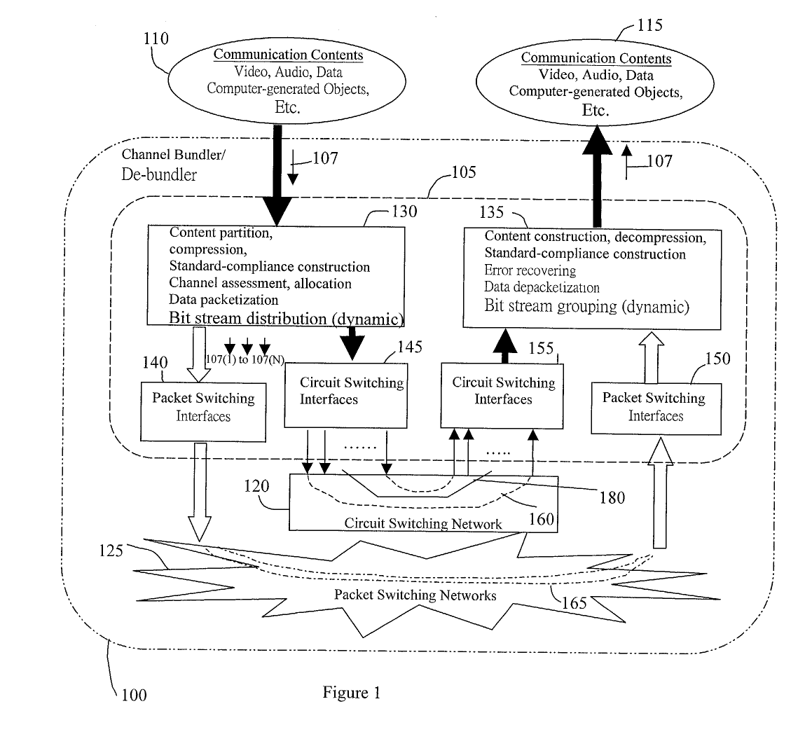

FIG. 1 is a block diagram of a telecommunications system 100 that can implement a virtual broadband communication channel in accordance with a specific embodiment of the invention. The telecommunications system 100 permits the transmission of high bit rate content by bundling the existing narrowband (e.g., telephone) channels, while providing a guarantee to the quality of service. In one embodiment, the telecommunications system 100 employs multiple independent circuit switching channels and an optional packet switching link in one communication session to deliver communication contents such as broadband contents. The term “one communication session” may denote any time-sensitive communication event such as, for example, interactive video streaming. As another example, the term “one communication session” may denote any communication purpose served with a set of procedures (in real-time or non-real time), or various combinations of different types of procedures. As another example, the term “one communication session” may denote an interactive communication event. In one specific application, an embodiment of the invention may be used for, but not limited to, time-sensitive video streaming that is interactive and has a bit rate below approximately one (1) Mbps. Of course, it will be appreciated that the invention may be used for other applications where the other applications may have different bit rate requirements.

In another application, the telecommunications system 100 employs a packet switching channel and multiple circuit switching channels to implement a reliable router which can guarantee the QoS in an otherwise packet switching data network. In this case, when the router experiences congestion in the packet switching channel, the router can send the high priority packets to “hyper-jump” through the circuit switching channels directly to the destinations, or other routers, which are in the less congested area.

The telecommunications system 100 includes a channel bundler & de-bundler stage 105 that receives communication content(s) 107 from a source 110 and outputs communication content(s) 107 to a destination 115. For purposes of explaining the functionality of the present invention, the term “communication content” may be singular or plural in number. The communication content 107 may be, for example, video data, audio data, text, computer-generated objects, or other data, multi-media content, or a combination of different types of data. The multi-media content may include video, audio, computer-generated objects, and/or text. The multi-media content may be in interactive form or non-interactive form and may be obtained in, for example, one deliverable content base. After the communication content 107 is received by the stage 105, the communication content 107 is decomposed or partitioned into sub-streams 107(1), 107(2), . . . 107(N) (where N is an integer) so that a portion of the communication content 107 may be transmitted by stage 105 via circuit switching network 120, while another portion of the communication content 107 may be transmitted by stage 105 via packet switching network 125, depending on the priority or nature of the communication content portion as described below. Of course, the communication content 107 may be decomposed into sub-streams and transmitted entirely via the circuit switching network 120. For example, this would be the case if the packet switching networks 125 is omitted or rendered inoperable. As another example of the above case, the communication content 107 may be decomposed into sub-streams and the sub-streams may be selectively sent to along the circuit switching network 120 if the transmission of the communication content 107 requires a short transmission delay.

By decomposing the communication content 107 into smaller portions (or sub-streams) 107(1) to 107(N), the transmission delay of each portion across a channel can be managed with flexibility. The transmitted smaller portions 107(1) to 107(N) are then reconstructed into the original communication content 107 signal, for example, at or near the receiving end or destination 115. Thus, the system 100 permits broadband transmission of data, while achieving predictable transmission delay.

In one embodiment, the stage 105 includes an input stage 130 for receiving the communication content 107 and an output stage 135 for sending the communication content 107 to destination 115. The details of the input stage 130 and the output stage 135 are described below in additional detail. At least one packet switching interface 140 is typically coupled between the input stage 130 and the packet switching networks 125, while at least one circuit switching interface 145 is typically coupled between the input stage 130 and the circuit switching network 120. At least one packet switching interface 150 is typically coupled between the output stage 135 and the packet switching networks 125, while at least one circuit switching interface 155 is typically coupled between the output stage 135 and the circuit switching network 120.

The circuit switching network 120 may be formed by, for example, POTS, ISDN, wireless mobile channels (e.g., 2G mobile channels such as Global System for Mobile Communications or GSM and Code Division Multiple Access or CDMA), or a combination of various types of these channels. The packet switching networks 125 may be formed by a true broadband media such as, for example, fiber optics or Ti lines. The packet switching networks 125 can manage different types of Internet Protocol (IP) packets.

Thus, in accordance with an embodiment of the invention, a data stream 107 is decomposed into smaller bit sub-streams 107(1) to 107(N), and each smaller bit sub-stream is transmitted across an appropriate channel (e.g., circuit switching network 120 or packet switching networks 125). Near the receiving end, the sub-streams 107(1) to 107(N) are reconstructed into the original data stream 107.

It is noted that in the specific embodiment shown in FIG. 1, multiple independent circuit switching channels (as represented by path 160) are used to transmit sub-streams of a communication content where flexible management of transmission delay across a channel is desirable. The bandwidths of existing telephone lines are in general narrow. The most commonly used channel is a two-way channel that operates with phone modems over POTS. This type of two-way channel has a bit rate up to approximately 33.6 Kbps. It is further noted that, as an example, the data rate for a high quality compressed video is between approximately 128 Kbps and 384 Kbps. Therefore, if, for example, about twelve (12) or more POTS line are used (i.e., “bundled”), then a fairly high quality video stream can be transmitted across the circuit switching network 120 without being negatively affected by the absence of broadband links. Some useful applications that are permitted by the specific embodiment in FIG. 1 include video conferencing, real-time event broadcasting, security surveillance, and/or video monitoring. As also described below, secured transmission features may be included in telecommunication system 100 for use in secured information transfer applications. By partitioning the stream of communication content 107 into sub-streams 107(1) to 107(N) and transmitting each sub-stream via an associated POTS line in the circuit switching network 120, the limited bandwidth problem of POTS lines are avoided by an embodiment of the invention.

It is noted that in another embodiment, the packet switching networks 125 (with the packet switching channels, as represented by path 165) may be omitted or rendered as inoperable in FIG. 1, depending on the particular application.

In another application, the telecommunications system 100 employs a packet switched channel 165 and multiple circuit switched channels 160 to implement a reliable router which can guarantee the QoS in an otherwise packet switched data network. In this case, when the router experiences congestion in the packet switched channel 160, the router can send the high priority packets to “hyper-jump” through the circuit switched channels 160 directly to the destinations, or other routers, which are in the less congested area.

In one embodiment, a non-interactive portion of the data stream 107 can be transmitted across a broadcast channel 180 (FIG. 1), which may be a part of or separate from the circuit switching network 120. The broadcast channel may be, for example, a broadcast television channel, a broadcast radio channel, a radio channel, a cable television channel, a pager channel or another type of broadcast channels.

Input Stage 130

The additional details of the input stage 130 are now discussed. In one embodiment, the input stage 130 can perform at least some of following functions as discussed in the below sub-headings.

(1) Content partition:

The communication content 107 (which may be a higher resolution data stream) can be decomposed into multiple lower resolution component data sub-streams by any one of various methods as, for example, described in U.S. Provisional Application No. 60/291,910. The communication content 107 can be partitioned into objects, blocks, or scenes, and the communication channels can be dynamically allocated (as discussed in detail below) for transmitting content based on the characteristics of the communication contents that are partitioned. Alternatively or in addition, the communication channels may be allocated based on the quality and/or availability of the channels. The allocation of channels advantageously facilitates the delivery of a scalable communication content. The communication content characteristics may include, for example, priority, sources of the communication contents, defined objects, rate of change, communication content importance (data stream importance), security level (data stream security level), and/or other characteristics. It is also noted that characteristics of the communication content are not limited to the above-listed factors.

One method of data stream decomposition is by spatial interleaving, as described in U.S. Provisional Application No. 60/291,910, where, for example, each lower resolution component of a video stream still shows the entire picture but has a coarser appearance. For example, one component video stream may include particular pixel values at coordinates (i,j) of a frame, while another component video stream may include other particular pixel values at other coordinates of the same frame. Subsequent frames at subsequent times t are also decomposed in the same manner.

A higher resolution data stream can also be decomposed into multiple lower resolution data streams based on spatial region, as also described in U.S. Provisional Application No. 60/291,910. For example, a frame may be decomposed into multiple components where each component includes particular pixel values at a defined frame region.

A higher resolution data stream can also be decomposed into multiple lower resolution data streams by temporal interleaving, as also described in U.S. Provisional Application No. 60/291,910. Each frame will, for example, be processed by an associated processor in a processor pool. Temporal interleaving may involve, for example, the use of additional buffers in hardware, or additional memory areas for a software-based embodiment.

A higher resolution data stream can also be decomposed into multiple lower resolution data streams based on temporal region, as also described in U.S. Provisional Application No. 60/291,910. A higher resolution data stream can also be decomposed into multiple lower resolution data streams based on a combination of spatial and temporal decomposition.

A higher resolution data stream can also be decomposed into objects, scenes, blocks, and/or background sub-streams based on a specified rule set or pattern recognition strategy. The criteria or discriminating rules can include, but are not limited to, shape, area, contrast, tempo, and/or any combinations thereof. As an example, the input stage 130 can be set to detect an area and a motion change rate (i.e., tempo) and acquire events (e.g., sub-streams) from a high-resolution video stream. This is a very useful feature in a security monitoring system. The acquired event normally carries higher priority for transmission.

(2) Compression:

The multiple lower resolution data sub-streams 107(1) to 107(N) that are generated as a result of decomposing the communication content 107 may be compressed (encoded) to optimize transmission along the channels. Compression can be performed at the entire communication content (data stream) level or at the sub-stream level.

As an example, communication content that includes video maybe compressed by various compression techniques such as H.261, H.263, MPEG-1, MPEG-2, MPEG-4, or by other suitable compression techniques. The use of different compression techniques will typically require different bandwidth resources.

As another example, communication content that includes audio may be compressed by various speech compression algorithms (e.g., G.728 or G.729) or by high quality stereo sound compression techniques (e.g., MP3 or Advanced Audio Compression (AAC)). The use of different compression techniques will typically require different bandwidth resources. The use of compression techniques in combination with the above-described transmission method across the circuit switching channels 160 (FIG. 1) is useful for various important applications such as, for example, video conferencing, surveillance systems, security systems, and/or live event broadcasting applications.

The compressed data sub-streams are typically synchronized prior to transmission along the circuit switching network 120 or packet switching networks 125.

(3) Standard-Compliance Construction:

The sub-streams resulting from the above partitioning and compression methods are typically further arranged into standard-compliant formats. The representative standards allowing such flexibility include, for example, MPEG-4/7/21 by ISO (International Standard Organization) and H.263/323/324 by ITU (International Telecommunications Union). The selection of the standard for use depends on the user applications. Each sub-stream may be further divided into groups, as needed, in order to assign the priority and/or an importance weight associated with each group. This division process will not affect the format compliance but enhance flexibility for the purpose of effective transmission to be described below.

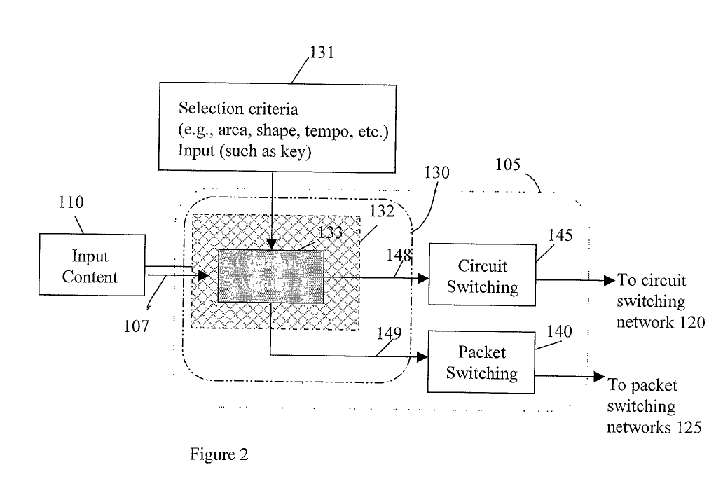

Consider the same example as in subsection (1) above on Content Partition. As shown in FIG. 2, the circuit 132 constructs the bit stream in accordance with the selected standard. It is noted that in another embodiment, the circuit 132 may be implemented in software. The circuit 131 contains the criteria for selecting certain scene or video event. As discussed above, this criteria may be, for example, shape, area, contrast, tempo, and/or other discriminating rules or combination of rules. Circuit 133 will compare the input bit stream 107 against the requirements set by circuit 131. The portion of the bit stream meeting the requirements will be separated from the input bit stream 107. Each input criterion has the priority or the weight of importance associated with it. The selected sub-streams are then routed to the appropriate channel for transmission. The path 148 (FIG. 2) is used by the selected sub-streams with high priority, and is connected to circuit switching interfaces 145 and circuit switching channels 160. The path 149 (FIG. 2) is for the remaining bit stream(s) normally with less or no priority and, hence, this path 149 is connected to the packet switching interfaces 140 and packet switching networks 125.

(4) Channel Assessment and Allocation:

The availability and the quality are two important factors specifying the channels. One of the important benefits of at least one embodiment of the invention is the independent scalability of the bandwidth. When the narrow band channels (in circuit switching network 120 in FIG. 1) are not in use, they are put in a pool of virtual broadband resource. Thus, the availability of the channels is a time varying factor. Furthermore, the quality of each channel may vary as a function of time. In turn, the available channel capacity and its latency may change in time. As a result, the input stage 130, at all times, has full knowledge of the quantity and the priority structure of the input data stream 107, as well as the available channel resources and, hence, is capable of allocating the channel use. The channel allocation criteria may include, but not limited to, maximizing the channel throughput rate as well as the content quality. For example, a person may be making a speech or presentation. The person may be moving frequently, while the background scene may be static and/or has little change for a longer period of time. In this example, as determined by the circuit 132 (FIG. 2) the bit streams representing the person will be transmitted over the available channels (e.g., channels 160 in FIG. 1) in the circuit switching network 120, while the bit streams representing the background scene may be sent over the channels 165 in the packet switching networks 125 in an embodiment where the packet switching networks 125 are available or implemented.

(5) Data Packetization:

The bit streams transmitted through the packet switching interface 140 will typically be packetized in accordance with the format imposed by the selected packet switching network 125. The packetization specified herein may not be necessarily associated with the partitioning/construction rules described above in subsection (1) and subsection (3), respectively. The packetization can also be applied to the bit streams transmitted through the circuit switching interface 145 for easy partition, distribution, and assembly.

(6) Bit Stream Distribution (E.g., Dynamic Distribution):

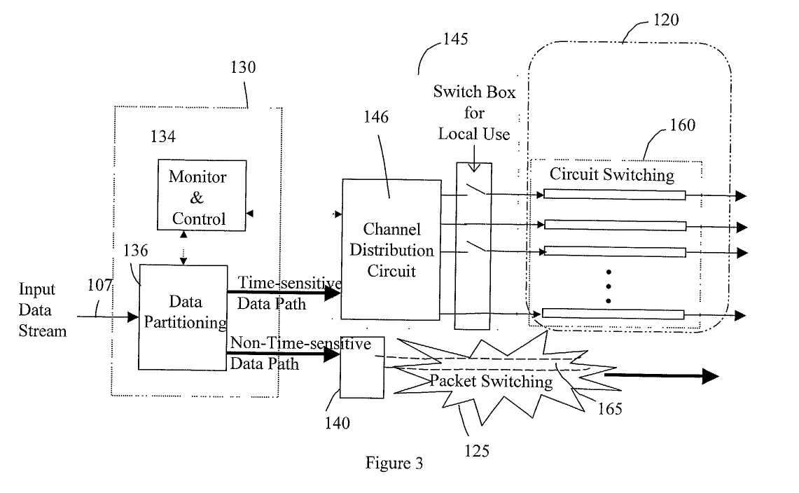

As stated above, the communication content 107 is partitioned into multiple bit sub-streams 107(1) to 107(N), and each multiple bit sub-stream is transmitted along an assigned channel. Sub-streams partitioned from a communication content 107 that requires a low transmission delay (or time critical contents) are assigned (by circuit 132) for transmission along selected channels in the circuit switching network 120. These selected channels may vary and are illustrated by the path 160 in the circuit switching network 120. Sub-streams partitioned from a communication content 107 where the transmission delay is less critical are typically assigned (by circuit 132 in FIG. 2) for transmission along selected channels in the packet switching networks 125. These selected channels may vary and are illustrated by the path 165 in the circuit switching network 120. More specifically as shown in FIG. 3, the circuit 134 monitors the channel conditions and the characteristics of the partitioned data sub-streams 107(1) . . . 107(N) at all times. The results of this circuit function will determine the channel use to maximize the channel efficiency.

Consider the previous content example where a person is making a presentation to a group of audience. The bit stream representing the fast moving part related to the person's interactions may be assigned to circuit switching channels 160 (in circuit switching network 120), and the number of circuit switching channels 160 that are needed (i.e., selected and used) may vary depending on the movement of the interaction. The background bit streams may go over the packet switching link 165 (in the packet switching networks 125) because of the non-time critical nature of these background bit streams. All these dynamic bit allocation functions are performed by circuit 134 (and by circuit 136 for data partitioning). The circuit 136 outputs time sensitive data for input into the channel distribution circuit 146 for transmission along circuit switching channels 160. The circuit 136 also outputs non-time-sensitive data into the packet switching interfaces 140 for transmission along packet switching channels 165 (in an embodiment where the packet switching networks 125 are available or implemented). The channel distribution circuit 146 in FIG. 3 is the interface between the monitor and control box 134 on the left and the phone line (e.g., POTS line or circuit switching channels 160) connection on the right. The channel distribution circuit 146 equivalently performs the function as an intelligent local switch.

Output Stage 135

The additional details of the output stage 135 of FIG. 1 are now discussed. In one embodiment, the output stage 135 can perform at least some of the following functions as discussed in the below sub-headings.

(1) Content Re-Construction:

The multiple sub-streams that are transmitted along circuit switching network 120 or packet switching networks 125 are then reconstructed into the original communication content 107. The re-construction procedure is basically the reversed process of the content partition procedure with the addition of error compensation as to be discussed in subsection (4) below.

(2) Decompression:

The multiple sub-streams 107(1) to 107(N) (or the reconstructed communication content 107) may also be decompressed (decoded) by use of standard methods.

(3) Standard-Compliance Re-Construction:

The output stage 135 will follow the reversed transmission procedure to re-construct the standard-compliant bit streams. Specifically, the steps performed in the standard-compliance construction above are reversed in this standard-compliance re-construction step.

(4) Error Recovery:

Spatial/temporal interpolation or inference methods or other suitable methods may be used to fill in any missing data sub-streams or to fill in a missing portion of an inside of a data component. Due to the care for various importance weights assigned to groups in the sub-streams, the content quality degradation resulting from missing data can be managed to a minimum effect and is non-catastrophic. As a result, graceful degradation can be achieved.

(5) Data De-Packetization:

The output stage 135 will follow the reversed transmission procedure to ensure a proper de-packetization procedure and to maintain the integrity of the data stream.

(6) Bit Stream Grouping:

The output stage 135 will follow the reversed transmission procedure to ensure a proper re-grouping procedure and to maintain the integrity of the data stream.

In another embodiment of the invention, the packet switching interfaces 140 and 150 and the packet switching networks 125 are omitted, not used, or rendered inoperable. In this embodiment, the circuit switching network 120 transmits the multiple sub-streams 107(1) to 107(N) that have been partitioned from the high resolution communication content 107. Thus, high resolution content data, such as video, can be transmitted along the circuit switching channels 160 in the circuit switching network 120, to achieve real-time or near real-time transmission and broadband capabilities.

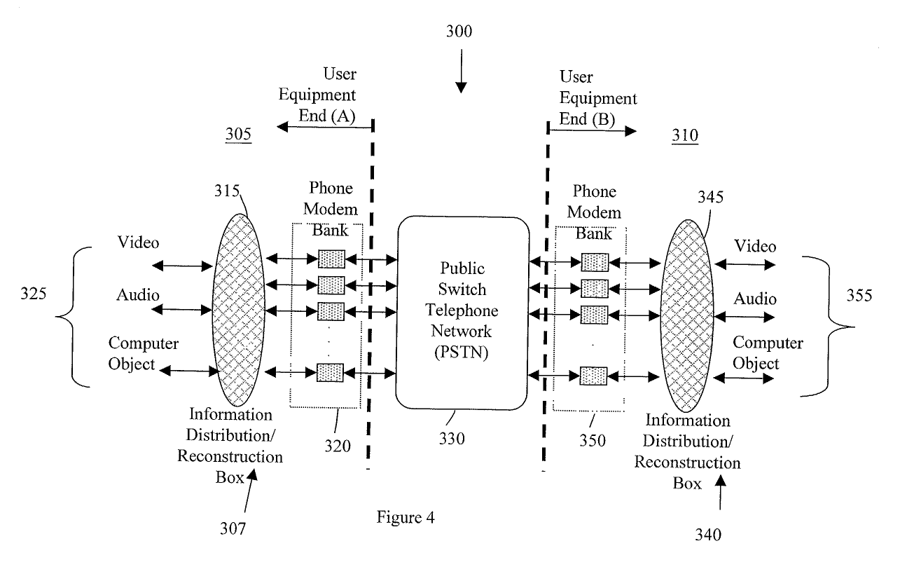

FIG. 4 is a block diagram illustrating one particular application of a specific embodiment of the present invention. Assume that two users have similar equipments (equipment 305 at end (A) and equipment 310 at end (B)). The suite 307 with the user equipment 305 may include an Information Distribution/Reconstruction Box (IDRB) 315 and a bank 320 of phone modems. The input/output (I/O) terminals of the suite 307 are coupled to multi-media information sources 325 (for generating, e.g., video, audio, or computer-generated objects) and to a public switched telephone network (PSTN) 330.

The suite 340 with the user equipment 310 may include an IDRB 345 and a bank 350 of phone modems. The input/output (I/O) terminals of the suite 340 are coupled to multi-media information sources 355 (for generating, e.g., video, audio, or computer-generated objects) and to the PSTN 330. The number of phone modems in one bank typically ranges from, for example, 6 to 12 modems. It is noted that this range is not limiting and the number of phone modems may vary. Each modem is, for example, an off-the-shelf component compliant with the International Communication Union (ITU) V.34 standard. In the specific embodiment shown in FIG. 4, all the phone modems are typically independent in operation. The functions that can be performed by an IDRB can include, for example, the above-described partitioning of information streams, packetization of the information streams, dynamic access of channels, allocation of usage of channels, and/or the functions (e.g., content re-construction) performed by output stage 135. Due to the predictable quality of service permitted by the system 300, the system 300 permits a very reliable reconstruction of the information stream. As a result, the system 300 permits the transmission and distribution of high quality compressed data (e.g., video) over regular POTS lines. Since ISDN (Integrated Service Digital Network) has the same characteristics as POTS in terms of quality of service, the system 300 can be modified for use with ISDN as well. The ISDN service is carried out via a leased line normally provided and installed by local telephone companies. The small difference in installation between ISDN and POTS is transparent to embodiments of the invention.

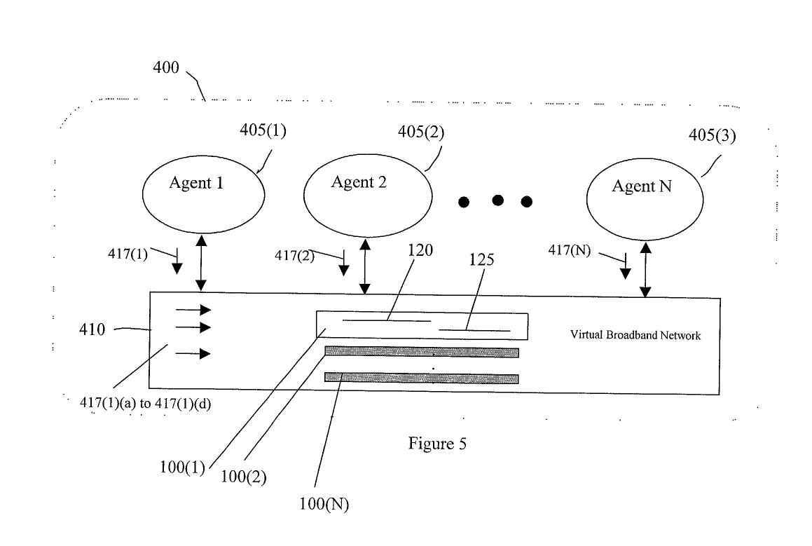

FIG. 5 is a block diagram of a system 400 in accordance with another specific embodiment of the invention. The system 400 includes multiple communication agents (e.g., agents 405(1), 405(2), . . . 405(N) where N is an integer) coupled to together by a virtual broadband network 410. It is understood that the number of communication agents 405 may vary in number. The virtual broadband network 410 may be formed by a plurality of virtual broadband channels where a virtual broadband channel is, for example, implemented by the telecommunication system 100 of FIG. 1. In the particular example of FIG. 5, the multiple communication agents 405(1), 405(2), and 405(N) can function simultaneously with the virtual broadband network 410 to support a distributed application, such as, for example, multiple-way (e.g., 3-way) video conferencing between the agents 405. In another application, the agents 405 can also be used to permit multiple-site surveillance/monitoring where each agent 405 is located in a different site. Thus, the agents 405 communicate with each other via the virtual broadband network 410 to permit multi-way communications between the agents 405.

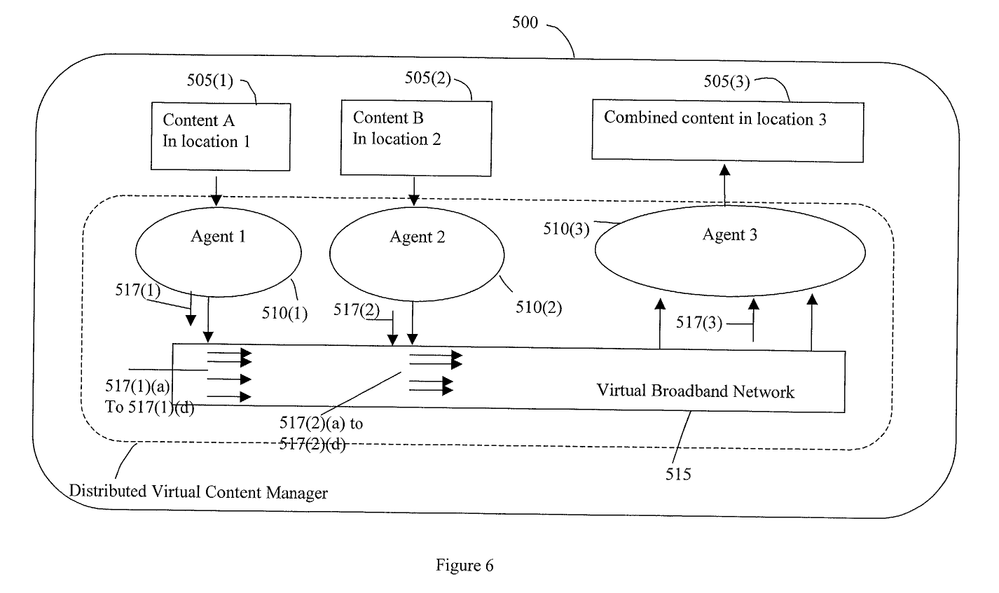

Specifically, the first agent 405(1) can send communication content 417(1) or receive communication content (e.g., any of content 417(2) through 417(N)) along the virtual broadband network 410. The second agent 405(2) can send communication content 417(2) to the first agent 405(1) (or to any other selected agents coupled to the network 410) or receive communication content 417(1) from the first agent 405(1) (or other selected contents from other agents coupled to the broadband 410). The agent 405(N) may receive communication content from any of the other agents coupled to the network 410 and may send communication content 417(N) to any of the other agents coupled to the network 410. The communication contents 417 are transmitted along the virtual broadband network 410. As stated above virtual broadband network 410 includes a plurality of virtual broadband channels 100(1) through 100(N). As an example, the virtual broadband channel 100(1) includes the circuit switching network 120 and may also include the optional packet switching networks 125. The communication content 417(1) is transmitted as, for example, sub-streams 417(1)(a), 417(1)(b), 417(1)(c), and 417(1)(d) along at least one of the circuit switching networks and/or packet switching networks formed by the virtual broadband channels 100(1) through 100(N). The number of sub-streams may vary. As similarly noted above, if the sub-streams 417(1)(a) through 417(1)(d) form a content that requires a short transmission delay, then the sub-streams are selected for transmission along at least one of the circuit switching networks in the virtual broadband network 410. FIG. 6 is a block diagram of a system 500 where contents from multiple sites can be obtained for presentation at another site. For example, content A 517(1) in location 505(1) and content B 517(2) in location 505(2) are obtained by agent 510(1) and agent 510(2), respectively. The contents obtained from locations 505(1) and 505(2) are then delivered via the virtual broadband network 515 to a location 505(3) as combined content 517(3) by use of agent 510(3). It is understood that the number of locations 505 and agents 510 may vary. The virtual broadband network 515 may be formed by a plurality of virtual broadband channels where a virtual broadband channel is, for example, implemented by the telecommunication system 100 of FIG. 1. Each virtual broadband channel includes a circuit switching network (such as circuit switching network 120) with circuit switching channels (such as channels 160) and optional packet switching networks (such as packet switching networks 125) that are capable to transmit the sub-streams of the content 517.

As an example, agent 510(1) may be a camera used by a reporter at the location 505(1), while agent 510(2) may be another camera used by another reporter at another location 505(2). The content 517(1) and content 517(2) captured by the agents 505(1) and 505(2) are then transmitted via virtual broadband network 515 and delivered to agent 510(3) which may be, for example, a display device at the location 505(3). The display device may, for example, show the combined content 517(3) as events captured by agents 510(1) and 510(2) in a live picture-in-picture or split-screen broadcast. In another example, one of the content 517(1) and content 517(2) may be shown in the screen foreground as a picture overlay, while the other content is shown in the screen background.

As another example, agent 510(1) may be a camera used by a reporter at the location 505(1), while agent 510(2) may be a processor for retrieving content in a database (not shown) in location 505(2). Thus, in this example, if agent 510(3) is a display device in location 505(3), then the image shown in the display device may be a still picture (i.e., content 517(2)) in the display device screen background and a live broadcast (i.e., content 517(1)) in the display device screen foreground, where the still picture is obtained from the database and the live broadcast is captured by agent 510(1) at location 505(1).

Secured Communication Feature

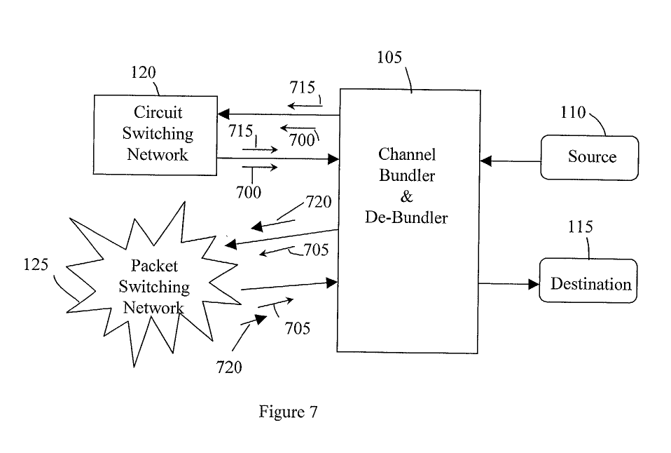

Data encryption is often a required feature in communication systems. Data streams are normally encrypted and decrypted using the same secret (security) key. Thus, this secret key normally has to be distributed to at least two different locations, and protection of this key becomes an essential issue. Consequently, as shown in a specific embodiment in FIG. 7, the circuit switching channels 160 (in the circuit switching network 120) may be employed to pass the secret key 700, because of the secured nature of the channels 160, while still passing encrypted data packets 705 over the public packet switching networks 125 to take advantage of the bandwidth utilization. The security key and its priority can be entered into the system via the circuit 131 (inside 105), as illustrated in FIG. 2. It normally does not require more than one circuit switching channel, although this is not a limiting factor.

Re-synchronization is an important feature in many standard-compliant bit streams. To ensure that the re-synchronization flag 715 can arrive at the destination 115 reliably, the synchronization flag 715 can be sent via the more reliable path such as circuit switching channels in the circuit switching network 120. The other content streams 720 can be sent over packet switching networks 125 to achieve bandwidth efficiency. Similar to the method described with respect to FIG. 2, the synchronization flag 715 and its priority will be entered by use of circuit 131. Transmission of the synchronization flag 715 normally does not require more than one circuit switching channel, although this is not a limiting factor.

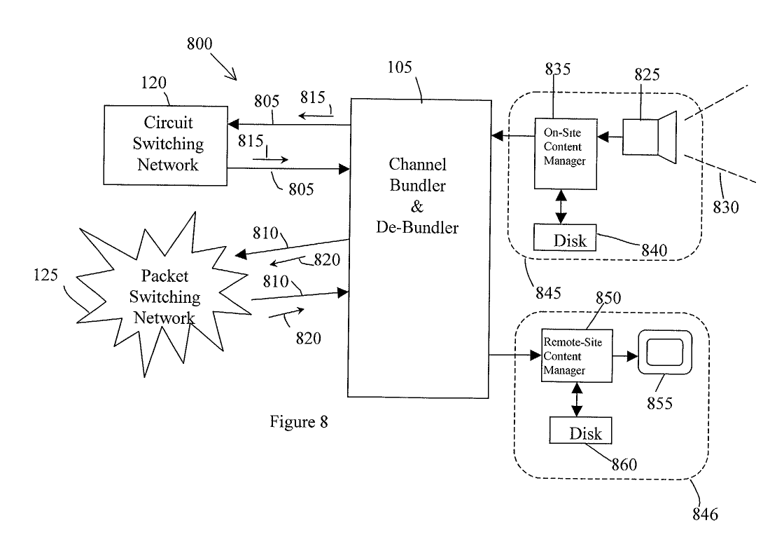

FIG. 8 is a block diagram of a high-end security monitoring system 800 in accordance with a specific embodiment of the invention. The telecommunications system 100 in FIG. 1 may be configured to deploy the high-end security monitoring system 800.

In this embodiment, there is shown one or more POTS line 805 (coupled between the channel bundler/de-bundler stage 105 and circuit switching network 120) and a T1 line 810 (coupled between the channel bundler/de-bundler stage 105 and the packet switching networks 125), as an example. It is noted that other types of circuit switching channels and packet switching channels may also be used, as an alternative or addition to POTS lines and T1 lines. The POTS lines 805 are bundled in a manner as described above to deliver real-time information 815, while the T1 line 810 is connected to, for example, an Internet Service Provide (ISP) (not shown in FIG. 8) to deliver broadband IP packets 820. An input device 825 in the security system 800 is, for example, continuously recording the scene 830 in location 845 and the recorded scenes are typically managed by an on-site content manager 835, and stored into, for example, a storage device 840 which may or may not be in the location 845. The input device 825 may also capture audio data in the scene 830. In one embodiment, the input device 825 is a camera with sound recording capability. The storage device 840 may be, for example, a high capacity local hard disk, a mass storage device, or another type of storage device. It is noted that the information stored in the storage device 840 may be overwritten. But, it is also typically guaranteed that the information (as captured by the input device 825) for a set past interval is available when retrieved from the storage device 840 (which is typically managed by the on-site content manager 835). When, for example, an alarm is triggered by an event, the important video data (which may not be high quality) is transmitted immediately over the POTS lines 805. This important video data may be represented by the information 815 that is transmitted with a very short transmission delay. Depending on the assessment made by a security operator from a remote site (destination) 846, high quality video (as captured by the input device 825) may be selected to transmit over the T1 line 810 via a packet switching networks 125. This high quality video may be represented by the packets 820 which may have a longer transmission delay. This high quality video can provide a more detailed information for further analysis but plays no role in offering real time information. The content transmitted to the remote site 846 is received and managed by the remote site content manager 850. The content can then be displayed on a display device 855 or stored into a storage device 860. The storage device 860 maybe, for example, a remote site disk, a mass storage device, or another type of storage device.

Other variations and modifications of the above-described embodiments and methods are possible in light of the foregoing teaching.

Further, at least some of the components of this invention may be implemented by using a programmed general purpose digital computer, by using application specific integrated circuits or field programmable gate arrays, or by using a network of interconnected components and circuits. Connections may be wired, wireless, by modem, and the like.

It is also within the scope of the present invention to implement a program or code that can be stored in an electronically-readable medium to permit a computer to perform any of the methods described above.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method of transmitting data across a telecommunication network, the method comprising:
partitioning a data stream into a plurality sub-streams;
transmitting a sub-stream across an assigned circuit switching channel in one communication session; and
reconstructing the plurality of sub-streams into a single data stream.

2. The method of claim 1 wherein the sub-streams from the partitioning of the data stream is represented by a packetization format.

3. The method of claim 1 wherein one communication session denotes a time-sensitive communication event.

4. The method of claim 1 wherein one communication session denotes an interactive communication event

5. The method of claim 1 wherein one communication session denotes any communication purpose served with a set of procedures in real-time or non-real time.

6. The method of claim 1 wherein one communication session denotes any communication purpose with various combinations of different types of procedures.

7. The method of claim 1 wherein the partitioning the data stream comprises:
partitioning the data stream based upon a characteristic of the data stream.

8. The method of claim 7 wherein the characteristic of the data stream is selected from at least one of priority, sources of the data stream, defined objects, defined areas, rate of motion change, data stream importance, and security level of data stream.

9. The method of claim 1 wherein the circuit switching channels include wired links.

10. The method of claim 1 wherein the circuit switching channels include wireless links.

11. The method of claim 1 wherein the partitioned data stream are transmitted across circuit switching channels that are bundled.

12. The method of claim 1, further comprising:
transmitting a lower priority portion of the data stream across a packet switching channel.

13. The method of claim 1, further comprising:
transmitting a non-interactive portion of the data stream across a broadcast channel.

14. The method of claim 13 wherein the broadcast channel includes at least one of a broadcast television channel, a broadcast radio channel, a cable television channel, a pager channel or another type of channel.

15. The method of claim 1 wherein the data stream includes multi-media content.

16. The method of claim 15 wherein the multi-media content includes at least one of video, audio, computer-generated objects, and text.

17. The method of claim 15 wherein the multi-media content includes an interactive characteristic.

18. The method of claim 15 wherein the multi-media content includes non-interactive characteristic.

19. The method of claim 15 wherein the partitioned data stream is based upon an object oriented multi-media standard.

20. The method of claim 19 wherein the object oriented multi-media standard is based upon one of MPEG 4, MPEG 7, or MPEG 21.

21. The method of claim 1 wherein a circuit switching channel is selected to transmit a particular sub-stream based on at least one of the characteristic of the sub-stream, the quality of the channel, and the availability of the channel.

22. The method of claim 1 wherein the reconstructing the plurality of sub-streams includes performing error compensation to minimize error effect in the reconstructed data stream.

23. The method of claim 1 wherein the data stream is related to time-sensitive video streaming.

24. The method of claim 23 wherein the time-sensitive video streaming includes an interactive characteristic.

25. The method of claim 23 wherein the time-sensitive video streaming has a bit rate below 1 Mbps.

26. The method of claim 1 wherein the data stream includes video.

27. The method of claim 26, further comprising:
performing compression on the video.

28. The method of claim 27 wherein the compression is based upon one of H.261, H.263, MPEG-1, MPEG-2, or MPEG-4.

29. The method of claim 27, wherein the video is used for one of video conferencing, surveillance, or live event broadcasting applications.

30. The method of claim 1 wherein the data stream includes audio.

31. The method of claim 30, further comprising: performing compression on the audio.

32. The method of claim 31 wherein the compression is based upon one of a speech compression technique or a stereo sound compression technique.

33. The method of claim 31, wherein the audio is used for one of video conferencing, surveillance, or live event broadcasting applications.

34. The method of claim 12 wherein the lower priority portion of the data stream is transmitted as packets across a packet switching channel.

35. The method of claim 34 wherein the packet is based on one of various protocols.

36. An article of manufacture, comprising:
a machine-readable medium having stored thereon instructions to:
partition a data stream into a plurality sub-streams;
transmit each sub-stream across an associated circuit switching channel in one communication session; and
reconstruct the plurality of sub-streams into a single data stream.

37. A method of transmitting secured information across a network, the method comprising:
transmitting a security key from a source to a destination along at least one circuit switching channel; and
transmitting encrypted data packets from the source to the destination along at least one packet switching channel, the security key capable to decrypt the encrypted data packets.

38. A method of re-synchronizing information across a network, the method comprising:
transmitting a synchronization flag from a source to a destination along at least one circuit switching channel; and
transmitting data packets from the source to the destination along at least one packet switching channel, the synchronization flag capable to re-construct video content from sub-streams collected from a de-bundler stage.

39. A method of performing at least one of the following activities, such as security monitoring, video conference, or live event broadcasting, the method comprising:
in response to an event, locally capturing video or audio data associated with a scene;
transmitting the video or audio data along a plurality of circuit switching channels; and
selectively transmitting the video or audio data along a plurality of packet switching channels.

40. The method of claim 39, further comprising:
storing the locally captured video or audio data in a storage device for subsequent transmission to a remote site.

41. The method of claim 40 wherein the storage device is a local hard disk

42. The method of claim 40 wherein the storage device is a mass storage device.

43. The method of claim 39 wherein the video or audio data is transmitted through a virtual broadband channel.

44. The method of claim 39, further comprising:
partitioning the video or audio data into sub-streams prior to transmitting the video or audio data along the circuit switching channels or the packet switching channels.

45. The method of claim 44, further comprising:
transmitting each sub-stream across an associated circuit switching channel or an associated packet switching channel.

46. The method of claim 44, further comprising:
reconstructing the plurality of sub-streams into a single data stream.

47. A method of performing multiple-way communication, comprising:
using a first agent to send or receive communication content along a virtual broadband network; and
using a second agent to send communication content to the first agent or receive communication content from the first agent by transmission of the communication content along the virtual broadband network;
wherein the virtual broadband network includes a plurality of virtual broadband channels, each virtual broadband channel comprising a plurality of circuit switching channels and a plurality of optional packet switching channels capable to transmit sub-streams of the communication content.

48. A method of obtaining content from multiple sites, comprising:
using a first agent to capture content from a first location and to send the content along a virtual broadband network; and
using a second agent to capture content from a second location and to send the content along the virtual broadband network;
using a third agent to process the content transmitted along the virtual broadband network and output the content at a third location;
wherein the virtual broadband network includes a plurality of virtual broadband channels, each virtual broadband channel comprising a plurality of circuit switching channels and a plurality of optional packet switching channels capable to transmit sub-streams of the content.

49. The method of claim 48 wherein the content from the first location and the second location are live events, and wherein the live events are shown concurrently by the third agent.

50. The method of claim 48 wherein the content from the first location is a live event, wherein the content from the second location is a static event, and wherein the third agent can concurrently show the live event and static event.

51. A method of implementing a reliable router with guaranteed quality of service, the method comprising:
employing a packet switched channel and multiple circuit switching channels in an otherwise packet switching data network;
when the router experiences congestion in the packet switching channel, sending high priority packets through the circuit switching channels directly to at least one destination.

52. The method of claim 51 wherein the high priority packets hyper-jumps through the circuit switching channels.

53. The method of claim 51 wherein the destination includes another router.

54. The method of claim 51 wherein the destination is in a less congested area.

55. An apparatus for transmitting data from a source to a destination, the system comprising:
a channel bundler and de-bundler capable to partition a data stream into a plurality of sub-streams, the data stream transmitted from the source, the channel bundler and de-bundler capable to reconstruct the sub-streams into a single data stream for transmission to the destination; and
a plurality of circuit switching channels communicatively coupled to the channel bundler and de-bundler and capable to transmit an assigned sub-stream.

56. The apparatus of claim 55, further comprising:
a plurality of packet switching channels communicatively coupled to the channel bundler and de-bundler and capable to transmit a sub-stream from the data stream, the sub-stream having a lower priority characteristic.

57. The apparatus of claim 55 wherein the sub-stream is represented by a packetization format.

58. The apparatus of claim 55 wherein the data stream is transmitted as sub-streams in one communication session.

59. The apparatus of claim 58 wherein one communication session denotes a time-sensitive communication event.

60. The apparatus of claim 58 wherein one communication session denotes an interactive communication event.

61. The apparatus of claim 58 wherein one communication session denotes any communication purpose served with a set of procedures in real-time or non-real time.

62. The apparatus of claim 58 wherein one communication session denotes any communication purpose with various combinations of different types of procedures.

63. The apparatus of claim 55 wherein the data stream is partition based upon a characteristic of the data stream.

64. The apparatus of claim 63 wherein the characteristic of the data stream is selected from at least one of priority, sources of the data stream, defined objects, defined areas, rate of motion change, data stream importance, and data stream security level.

65. The apparatus of claim 55 wherein the circuit switching channels include wired links.

66. The apparatus of claim 55 wherein the circuit switching channels include wireless links.

67. The apparatus of claim 55 wherein the partitioned data stream are transmitted across circuit switching channels that are bundled.

68. The apparatus of claim 55, further comprising:
a packet switching channel communicatively coupled to the partitioning stage and capable to transmit a lower priority portion of the data stream.

69. The apparatus of claim 55, further comprising:
a broadcast channel communicatively coupled to the partitioning stage and capable to transmit a portion of the data stream.

70. The apparatus of claim 69 wherein the broadcast channel comprises one of a broadcast television channel, a broadcast radio channel, a cable television channel, a pager channel, or another type of channel.

71. The apparatus of claim 55 wherein the data stream includes multi-media content.

72. The apparatus of claim 71 wherein the multi-media content includes at least one of video, audio, computer-generated objects, and text.

73. The apparatus of claim 71 wherein the multi-media content includes an interactive characteristic.

74. The apparatus of claim 71 wherein the multi-media content includes non-interactive characteristic.

75. The apparatus of claim 55 wherein the data stream is partitioned based upon an object oriented multi-media standard.

76. The apparatus of claim 75 wherein the object oriented multi-media standard is based upon one of MPEG 4, MPEG 7, or MPEG 21.

77. The apparatus of claim 55 wherein a circuit switching channel is selected to transmit a particular sub-stream based on at least one of the characteristic of the sub-stream, the quality of the channel, and the availability of the channel.

78. The apparatus of claim 55 wherein the reconstructing the plurality of sub-streams includes performing error compensation to minimize error effect in the reconstructed data stream.

79. The apparatus of claim 55 wherein the data stream is related to time-sensitive video streaming.

80. The apparatus of claim 79 wherein the time-sensitive video streaming includes an interactive characteristic.

81. The apparatus of claim 79 wherein the time-sensitive video streaming has a bit rate below 1 Mbps.

82. The apparatus of claim 55 wherein the data stream includes video.

83. The apparatus of claim 82, further comprising:
performing compression on the video.

84. The apparatus of claim 83 wherein the compression is based upon one of H.261, H.263, MPEG-1, MPEG-2, or MPEG-4.

85. The apparatus of claim 83, wherein the video is used for one of video conferencing, surveillance, or live event applications.

86. The apparatus of claim 55 wherein the data stream includes audio.

87. The apparatus of claim 86, further comprising:
performing compression on the audio.

88. The apparatus of claim 86 wherein the compression is based upon one of a speech compression technique or a stereo sound compression technique.

89. The apparatus of claim 86, wherein the audio is used for one of video conferencing, surveillance, or live event broadcasting applications.

90. The apparatus of claim 68 wherein the lower priority portion of the data stream is transmitted as a packet across a packet switching channel.

91. The apparatus of claim 90 wherein the packet is based on one of various protocols.

92. A communication system for transmitting and receiving data information from a source to a destination, the system comprising:
a recording system;
an alarm system communicatively coupled to the recording system; and
a virtual broadband system capable to transmit information captured by the recording system;
wherein important video data in the captured information is transmitted over a plurality of bundled circuit switching channels in the virtual broadband system in response to a triggering by the alarm system;

93. The communication system of claim 92 a command or request is sent to the recording site from the destination via the circuit switching channels; and wherein high resolution data is then sent over a packet switching network at a delayed time.

94. The communication system of claim 93, further comprising: a storage device communicatively coupled to the virtual broadband system and capable to store the high resolution data.

95. A communication system comprising:
an input device capable to capture video or audio data associated with a scene;
a plurality of circuit switching channels coupled to the input device and capable to transmit the captured video or audio data; and
a plurality of packet switching channels coupled to the input device and capable to selectively transmit the captured video or audio data.

96. The communication system of claim 95 wherein the captured video or audio data are transmitted as sub-streams.

97. The communication system of claim 95 wherein sub-streams with higher priority are transmitted along the plurality of circuit switching channels.

98. The communication system of claim 95 wherein sub-streams with lower priority are transmitted along the plurality of packet switching channels.

99. The communication system of claim 95, further comprising:
a local storage device communicatively coupled to the input device and capable to store the data streams captured by the input device.

100. The communication system of claim 95, further comprising:
a reconstruction stage coupled to the circuit switching channels and packet switching channels and capable to reconstruct the video and audio data from received sub-streams.

101. An apparatus for transmitting data across a telecommunication network, comprising:
a partitioning stage capable to partition a data stream into a plurality sub-streams;
a plurality of circuit switching channels communicatively coupled to the partitioning stage, with each circuit switching channel capable to transmit a selected sub-stream in one communication session; and
a reconstruction stage communicatively coupled to the plurality of circuit switching channels and capable to reconstruct the plurality of sub-streams into a single data stream.

102. The apparatus of claim 101, further comprising:
a plurality of packet switching channels communicatively coupled to the partitioning stage and capable to transmit a sub-stream from the data stream, the sub-stream having a lower priority characteristic.

103. The apparatus of claim 101 wherein the sub-stream is represented by a packetization format.

104. The apparatus of claim 101 wherein the data stream is transmitted as sub-streams in one communication session.

105. The apparatus of claim 104 wherein one communication session denotes a time-sensitive communication event.

106. The apparatus of claim 104 wherein one communication session denotes an interactive communication event.

107. The apparatus of claim 104 wherein one communication session denotes any communication purpose served with a set of procedures in real-time or non-real time.

108. The apparatus of claim 104 wherein one communication session denotes any communication purpose with various combinations of different types of procedures.

109. The apparatus of claim 101 wherein the data stream is partition based upon a characteristic of the data stream.

110. The apparatus of claim 109 wherein the characteristic of the data stream is selected from at least one of priority, sources of the data stream, defined objects, defined areas, rate of motion change, data stream importance, and data stream security level.

111. The apparatus of claim 101 wherein the circuit switching channels include wired links.

112. The apparatus of claim 101 wherein the circuit switching channels include wireless links.

113. The apparatus of claim 101 wherein the partitioned data stream are transmitted across circuit switching channels that are bundled.

114. The apparatus of claim 101, further comprising:
a packet switching channel communicatively coupled to the partitioning stage and capable to transmit a lower priority portion of the data stream.

115. The apparatus of claim 101, further comprising:
a broadcast channel communicatively coupled to the partitioning stage and capable to transmit a portion of the data stream.

116. The apparatus of claim 115 wherein the broadcast channel comprises one of a broadcast television channel, a broadcast radio channel, a cable television channel, a pager channel, or another type of channel.

117. The apparatus of claim 101 wherein the data stream includes multi-media content.

118. The apparatus of claim 117 wherein the multi-media content includes at least one of video, audio, computer-generated objects, and text.

119. The apparatus of claim 117 wherein the multi-media content includes an interactive characteristic.

120. The apparatus of claim 117 wherein the multi-media content includes non-interactive characteristic.

121. The apparatus of claim 101 wherein the data stream is partitioned based upon an object oriented multi -media standard.

122. The apparatus of claim 121 wherein the object oriented multi-media standard is based upon one of MPEG 4, MPEG 7, or MPEG 21.

123. The apparatus of claim 101 wherein a circuit switching channel is selected to transmit a particular sub-stream based on at least one of the characteristic of the sub-stream, the quality of the channel, and the availability of the channel.

124. The apparatus of claim 101 wherein the reconstructing the plurality of sub-streams includes performing error compensation to minimize error effect in the reconstructed data stream.

125. The apparatus of claim 101 wherein the data stream is related to time-sensitive video streaming.

126. The apparatus of claim 125 wherein the time-sensitive video streaming includes an interactive characteristic.

127. The apparatus of claim 125 wherein the time-sensitive video streaming has a bit rate below 1 Mbps.

128. The apparatus of claim 101 wherein the data stream includes video.

129. The apparatus of claim 128, further comprising:
performing compression on the video.

130. The apparatus of claim 129 wherein the compression is based upon one of H.261, H.263, MPEG-1, MPEG-2, or MPEG-4.

131. The apparatus of claim 128, wherein the video is used for one of video conferencing, surveillance, or live event applications.

132. The apparatus of claim 101 wherein the data stream includes audio.

133. The apparatus of claim 132, further comprising:
performing compression on the audio.

134. The apparatus of claim 133 wherein the compression is based upon one of a speech compression technique or a stereo sound compression technique.

135. The apparatus of claim 132, wherein the audio is used for one of video conferencing, surveillance, or live event broadcasting applications.

136. The apparatus of claim 114 wherein the lower priority portion of the data stream is transmitted as a packet across a packet switching channel.

137. The apparatus of claim 136 wherein the packet is based on one of various protocols.

138. An apparatus for transmitting secured information across a network, comprising:
a stage capable to transmit a security key from a source to a destination along at least one circuit switching channel, and transmit encrypted data packets from the source to the destination along at least one packet switching channel, the security key capable to decrypt the encrypted data packets.

139. An apparatus for re-synchronizing information across a network, comprising:
a stage capable to transmit a synchronization flag from a source to a destination along at least one circuit switching channel, and transmit data packets from the source to the destination along at least one packet switching channel, the synchronization flag capable to re-construct video content from sub-streams collected from a de-bundler stage.

140. An apparatus for performing security monitoring, comprising:
a first stage capable to capture video data associated with a scene;
a plurality of circuit switching channels communicatively coupled to the first stage and capable to transmit the video data; and
a plurality of packet switching channels communicatively coupled to the first stage and capable to selectively transmitting the video data.

141. The apparatus of claim 140, further comprising:
a partitioning stage communicatively coupled to the first stage and capable to partition the video data into sub-streams prior to transmitting at least a portion of the video data along the circuit switching channels.

142. The apparatus of claim 141, wherein a higher priority sub-stream is transmitted across an associated circuit switching channel.

143. The apparatus of claim 140, further comprising:
a reconstruction stage communicatively coupled to the circuit switching channels and capable to reconstruct the plurality of sub-streams into a single data stream.

144. The apparatus of claim 140 wherein a sub-stream with a lower priority is transmitted along one of the packet switching channels.

145. The apparatus of claim 140, further comprising:
a storage device communicatively coupled to the first stage and capable to store the video data captured by the first stage.

146. An apparatus for performing multiple-way communication, comprising:
a virtual broadband network;
a first agent communicatively coupled to the virtual broadband network and capable to send or receive communication content along a virtual broadband network; and
a second agent communicatively coupled to the virtual broadband network and capable to send communication content to the first agent or receive communication content from the first agent by transmission of the communication content along the virtual broadband network;
wherein the virtual broadband network includes a plurality of virtual broadband channels, each virtual broadband channel comprising a plurality of circuit switching channels capable to transmit sub-streams of the communication content.

147. An apparatus for obtaining content from multiple sites, comprising:
a virtual broadband network;
a first agent communicatively coupled to the virtual broadband network and capable to capture content from a first location and to send the content along a virtual broadband network;
a second agent communicatively coupled to the virtual broadband network and capable to capture content from a second location and to send the content along the virtual broadband network; and
a third agent communicatively coupled to the virtual broadband network and capable to process the content transmitted along the virtual broadband network and output the content at a third location;
wherein the virtual broadband network includes a plurality of virtual broadband channels, each virtual broadband channel comprising a plurality of circuit switching channels capable to transmit sub-streams of the content.

148. The apparatus of claim 147 wherein the content from the first location and the second location are live events, and wherein the live events are shown concurrently by the third agent.

149. The apparatus of claim 147 wherein the content from the first location is a live event, wherein the content from the second location is a static event, and wherein the third agent can concurrently show the live event and static event.

150. A method of transmitting data across a telecommunication network, the method comprising:
partitioning a data stream into a plurality sub-streams;
transmitting a sub-stream across an assigned circuit switching channel; and
reconstructing the plurality of sub-streams into a single data stream.

151. The method of claim 148, further comprising:
transmitting lower priority sub-stream across an assigned packet switching channel.

152. A router with guaranteed quality of service, the router comprising: a packet switched channel;
communicatively coupled to the packet switched channel, multiple circuit switching channels in an otherwise packet switching data network;
wherein when the router experiences congestion in the packet switching channel, high priority packets are transmitted through the circuit switching channels directly to at least one destination.

153. The router of claim 152 wherein the high priority packets hyper-jumps through the circuit switching channels.

154. The router of claim 152 wherein the destination includes another router.

155. The router of claim 152 wherein the destination is in a less congested area.

156. An apparatus for transmitting data across a telecommunication network, the apparatus comprising:
means for partitioning a data stream into a plurality sub-streams;
coupled to the partitioning means, means for transmitting a sub-stream across an assigned circuit switching channel; and
coupled to the transmitting means, means for reconstructing the plurality of sub-streams into a single data stream.

157. The apparatus of claim 156, further comprising:
coupled to the partitioning means, means for transmitting lower priority sub-stream across an assigned packet switching channel.
